(19) United States
(12) Patent Application Publication
(10) Pub. No.: US 2025/0276200 A1
(43) Pub. Date: Sep. 4, 2025

(54) VEHICLE ESCAPE ACCESSORY

(71) Applicant: Armando Sada, San Pedro Garza Garcia (MX)

(72) Inventor: Armando Sada, San Pedro Garza Garcia (MX)

(21) Appl. No.: 19/019,049

(22) Filed: Jan. 13, 2025

Related U.S. Application Data
(60) Provisional application No. 63/620,564, filed on Jan. 12, 2024.

(51) Int. Cl. A62B 3/00; B26B 11/00; B60R 22/32

(52) U.S. Cl. CPC A62B 3/00; B26B 11/00; B60R 22/32; B60R 2022/328

(57) ABSTRACT

A vehicle escape accessory has a body sized and shaped to be receivable within a cup holder compartment in the interior of a vehicle. One or more vehicle escape tools are provided in or on the body. A driver or passenger within a vehicle and in need of escaping the vehicle can remove the body from the cup holder compartment and utilize the vehicle escape tool to facilitate escape from the vehicle. In one version, the vehicle escape tool comprises one or both of a window breaking tool and a seatbelt cutting tool.

### PRIORITY

The present application claims the benefit of domestic priority based on U.S. Provisional Patent Application 63/620,564 filed on Jan. 12, 2024, the entirety of which is incorporated herein by reference.

### BACKGROUND

The fear of being trapped in a vehicle and not being able to get out is a palpable one that almost every driver or passenger has experienced.

When a vehicle accident happens, sometimes a driver and/or passenger needs to quickly escape the vehicle. In most cases, this is easily done, and a vehicle occupant merely unfastens a seat belt, opens a door, and exits the vehicle either on his or her own or with the assistance of someone else. However, sometimes a vehicle occupant is in a situation where a conventional exit from a vehicle is not possible. For example, a severe accident might cause enough damage to a vehicle that it impedes escapability, such as by damaging a door to such an extent that it will not open or by breaking a seat belt release mechanism or making it unreachable.

In cases such as these, a trapped person can often use their phone to call for help if there is no one else on the scene. However, sometimes cell phones become displaced or unreachable as a result of the accident, and sometimes accidents happen in locations with poor phone service. Also, there are situations when a trapped occupant does not have the ability to wait until help arrives. For example, sometimes there is smoke, fire, or flood danger necessitating a quick escape. There is also the nightmare scenario of being in a vehicle that has become submerged in water and the doors will not open.

While the actual scenario of being in a situation where a quick escape is necessary is somewhat rare, the fear of being in these circumstances is real and common. Some individuals are so panic stricken by these thoughts they have recurring dreams or have difficulty driving over bridges or the like.

There is therefore a need for a way to help a trapped occupant escape a vehicle. There is a further need for a vehicle escape tool to help a trapped occupant escape a vehicle. There is a further need for a vehicle escape tool in the form of an easily reachable accessory. There is a further need for a handy and reliable accessory that can help alleviate the fear of being trapped in a vehicle.

### SUMMARY

The present invention satisfies one or more of these needs. In one aspect of the invention, a tool to help a trapped occupant escape a vehicle is provided.

In another aspect of the invention, a tool in the form of an easily reachable accessory to help a trapped occupant escape a vehicle is provided.

In another aspect of the invention, an accessory to help a trapped occupant escape a vehicle is provided in a known and handy location.

In another aspect of the invention, a vehicle escape accessory is provided, wherein the vehicle escape accessory has other uses.

In another aspect of the invention, a vehicle escape accessory is provided, wherein the vehicle escape accessory is storable in a cup holder compartment of the vehicle.

In another aspect of the invention, a vehicle escape accessory is provided, wherein the vehicle escape accessory is insertable into a cup holder of the vehicle.

In another aspect of the invention, a vehicle escape accessory is provided, wherein the vehicle escape accessory is a structural component of a cup holder of the vehicle.

In another aspect of the invention, a vehicle escape accessory comprises a body that has an escape tool region that houses, contains, or stores one or more escape tools.

In another aspect of the invention, a vehicle escape tool comprises an escape tool compartment located in the bottom portion of a vehicle escape accessory body and an additional accessory region in the top portion.

In another aspect of the invention, a vehicle escape tool comprises an escape tool compartment located in the bottom portion of a vehicle escape accessory body and an additional accessory region in the top portion, wherein the additional accessory region comprises a coin holder.

In another aspect of the invention, a vehicle escape tool comprises an escape tool compartment located in the bottom portion of a vehicle escape accessory body, wherein the escape tool compartment houses one or more vehicle escape tools, the vehicle escape tools comprising a window breaking tool, a seatbelt cutting tool, and/or another vehicle escape tool.

In another aspect of the invention, a vehicle escape tool comprises an escape tool compartment located in the bottom portion of a vehicle escape accessory body and an additional accessory region, wherein the vehicle escape tool is sized and shaped to be received in a cup holder compartment of a vehicle.

In another aspect of the invention, a vehicle escape tool comprises an escape tool compartment located in the bottom portion of a vehicle escape accessory body and an additional accessory region, wherein the vehicle escape tool is part of a cup holder compartment of a vehicle.

In another aspect of the invention, a vehicle escape tool comprises and combination of the above or below described features.

In another aspect of the invention, a method of escaping a vehicle comprises using a vehicle escape accessory including any of the above or below described features or combination thereof.

In another aspect of the invention, a method of being prepared to escape a vehicle in the event of a need to do so comprises storing a vehicle escape accessory including any of the above or below described features or combination thereof within reach in the interior of a vehicle.

In another aspect of the invention, a vehicle escape accessory comprises a body sized and shaped to be receivable within a cup holder compartment in the interior of a vehicle; and a vehicle escape tool in or on the body, wherein a driver or passenger within a vehicle and in need of escaping the vehicle can remove the body from the cup holder compartment and utilize the vehicle escape tool to facilitate escape from the vehicle.

In another aspect of the invention, a vehicle escape accessory comprises a body sized and shaped to be receivable within a cup holder compartment in the interior of a vehicle; and a vehicle escape tool in or on the body, wherein a driver or passenger within a vehicle and in need of escaping the vehicle can remove the body from the cup holder compartment and utilize the vehicle escape tool to facilitate escape from the vehicle, wherein the vehicle escape tool comprises a window breaking tool and/or a seatbelt cutting tool.

In another aspect of the invention, a vehicle escape accessory comprises a body sized and shaped to be receivable within a cup holder compartment in the interior of a vehicle; and a vehicle escape tool in or on the body, wherein a driver or passenger within a vehicle and in need of escaping the vehicle can remove the body from the cup holder compartment and utilize the vehicle escape tool to facilitate escape from the vehicle, wherein the body comprises an escape tool compartment in a bottom portion of the body, wherein the vehicle escape tool is contained within the escape tool compartment.

In another aspect of the invention, a vehicle escape accessory comprises a body sized and shaped to be receivable within a cup holder compartment in the interior of a vehicle; a window breaking tool and/or a seatbelt cutting tool in or on the body; and an additional accessory in or on the body, wherein a driver or passenger within a vehicle and in need of escaping the vehicle can remove the body from the cup holder compartment and utilize the vehicle escape tool to facilitate escape from the vehicle.

In another aspect of the invention, a vehicle escape accessory comprises a body sized and shaped to be receivable within a cup holder compartment in the interior of a vehicle; a window breaking tool and/or a seatbelt cutting tool in or on the body; and an additional accessory in or on the body, wherein a driver or passenger within a vehicle and in need of escaping the vehicle can remove the body from the cup holder compartment and utilize the vehicle escape tool to facilitate escape from the vehicle, wherein the additional accessory comprises one or more of a coin holder, a cup holder, and a power supply station.

In another aspect of the invention, a method of escaping a vehicle comprises providing an escape tool accessory in a cup holder compartment in the interior of a vehicle; removing the escape tool accessory from the cup holder when there is a need to escape the vehicle; and using the escape tool accessory to help facilitate escape from the vehicle.

In another aspect of the invention, a method of escaping a vehicle comprises providing an escape tool accessory in a cup holder compartment in the interior of a vehicle; removing the escape tool accessory from the cup holder when there is a need to escape the vehicle; and using the escape tool accessory to help facilitate escape from the vehicle, where the step of using the escape tool accessory to help facilitate escape from the vehicle comprises using the escape tool accessory to break a window and/or to cut a seatbelt.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic perspective view from the front and top of a version of a vehicle escape accessory of the invention;

FIG. 1B is a schematic top view of the vehicle escape accessory of FIG. 1A;

FIG. 2A is a schematic perspective view from the side of the vehicle escape accessory of FIG. 1A turned upside down;

FIG. 2B is a schematic perspective view from the front of the vehicle escape accessory of FIG. 2A;

FIG. 3 is a schematic perspective view of the vehicle escape accessory being positioned in the interior of a vehicle;

FIG. 4A is a schematic perspective view from the front and top of another version of a vehicle escape accessory of the invention;

FIG. 4B is a schematic perspective view from the front and top of another version of a vehicle escape accessory of the invention;

FIG. 4C is a schematic perspective view from the front and top of another version of a vehicle escape accessory of the invention;

FIG. 5A is a schematic perspective view from the front and top of another version of a vehicle escape accessory of the invention;

FIG. 5B is a schematic top view of the vehicle escape accessory of FIG. 5A;

FIG. 6A is a schematic perspective view from the front and top of another version of a vehicle escape accessory of the invention;

FIG. 6B is a schematic perspective view from the front and top of another version of a vehicle escape accessory of the invention;

FIG. 7 is a schematic perspective view from the front and top of another version of a vehicle escape accessory of the invention; and

FIG. 8 is a schematic perspective view from the front and top of another version of a vehicle escape accessory of the invention with a portion of the vehicle escape accessory being shown as a phantom.

### DESCRIPTION

The present invention relates to a vehicle accessory. In particular, the invention relates to a vehicle accessory useful for helping a trapped occupant escape a vehicle. Although the vehicle accessory is illustrated and described in the context of being useful for helping escape, the present invention can be useful in other instances. Accordingly, the present invention is not intended to be limited to the examples and embodiments described herein.

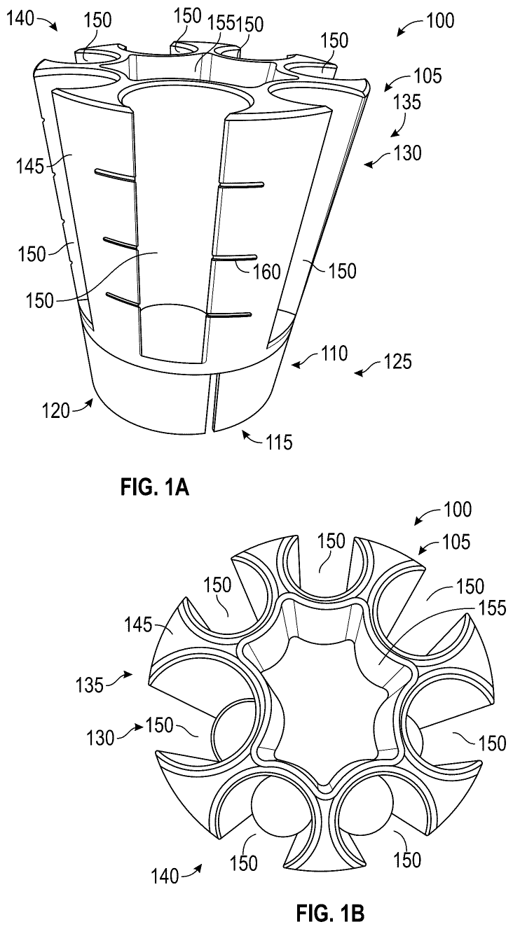

FIGS. 1A, 1B, 2A, 2B, 3, 4A through 4C, 5A, 5B, 6A, 6B, 7, and 8 show versions of a vehicle escape accessory 100 according to the invention. The vehicle escape accessory comprises a body 105 that has an escape tool region 110 that houses, contains, or stores one or more escape tools 115. By accessory it is meant any feature or element in or on a vehicle that is not directly associated with the driving operation of the vehicle. Accessories may come pre-installed in a vehicle or may be separately purchased. Accessories may be permanently housed in or on the vehicle, may be placed and housed in or on a permanent feature of the vehicle, may be come with a manner of attachment that allows the accessory to be attached to a location in or on the vehicle, or may simply reside somewhere in or on the vehicle, such as by sitting in a compartment in the vehicle. By escape tool it is meant any tool or implement that is designed to help facilitate the escape of a trapped vehicle occupant in some manner. By vehicle it is meant any type of vehicle capable of containing or carrying one or more individuals and capable or being driven directly, indirectly, remotely, autonomously, or the like, and includes by way of non-exhaustive examples an automobile, a car, a truck, a van, an SUV, an ATV, a tractor, a tractor trailer, a bus, an ambulance, a firetruck, a mail delivery vehicle, a military vehicle, a rescue vehicle, a recreational motor home, an executive motor coach, and the like.

One version of a vehicle escape accessory 100 is shown in FIGS. 1A and 1B. In this version, the escape tool region 110 of the body 105 of the vehicle escape accessory 100 is an escape tool compartment 120 located in the bottom portion 125 of the vehicle escape accessory body 105. Alternatively, the escape tool region 110 can be positioned at any other position on the body 105, such as the top or the side. As shown in the version of FIGS. 1A and 1B, the vehicle escape accessory 100 can also include an additional accessory region 130 which in this version is provided in the top portion 135 of the vehicle escape accessory 100. The additional accessory region 130 can comprise an additional accessory 140, such as an accessory that would be useful for a vehicle driver or other occupant while in the vehicle. For example, in the version of FIGS. 1A and 1B, the additional accessory 140 comprises a coin holder 145 which includes one or more coin slots 150 that can be sized and shaped to contain coins so that the coins are easily accessible to the driver or other occupant. In the particular version shown, the one or more coin slots 150 include different sized slots sized and shaped to hold different sized coins. The additional accessory 140 can also or alternatively include an optional storage compartment 155 that can hold various objects that the driver or occupant might need to access while in the vehicle. Optionally, indicia 160 can be provided to provide an indication of the number of coins in a coin slot 150.

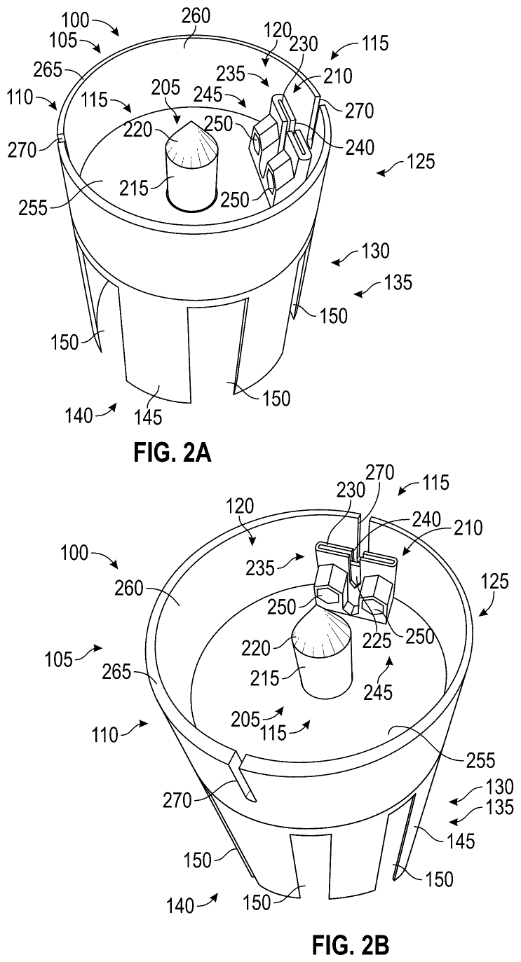

FIGS. 2A and 2B show the vehicle escape accessory 100 of FIGS. 1A and 1B turned upside down so that the bottom portion 125 and the escape tool region 110 can be viewed. Within the escape tool region 110 is one or more vehicle escape tools 115. The one or more vehicle escape tools 115 can be any tool that could be useful in helping a vehicle occupant escape a vehicle if and when the need arises. For example, in the version shown, the vehicle escape tool 115 comprise one or more of a window breaking tool 205 and/or a seatbelt cutting tool 210.

The window breaking tool 205 of the vehicle escape accessory 100 is designed to break tempered glass windows such as those commonly found in vehicles. The window breaking tool includes a tip member 215 made of hard material, such as one or more of steel, tungsten carbide, ceramic, diamond, and the like that is shaped to form a point 220 designed to make it easier to cause a window to break when the tip member 215 is advanced quickly at the window so that the window is struck with force by the point 220. A tip member 215 of the type shown in FIGS. 2A and 2B are commonly found on emergency hammer devices, also known as bus mallets, dotty hammers, safety mallets, and bus hammers.

In use, a user such as a vehicle driver or other occupant would grasp the vehicle escape accessory 100 and would quickly advance the bottom portion 125 at the window to be broken so that the point 220 of the tip member 215 contacts the window with enough force to cause the window to break. A tempered window will shatter when struck with the tip member 215 with sufficient force. The force can either be generated by the manual advancement of the vehicle escape accessory 100 by the user or a spring mechanism can be provided to spring load the tip member 215 to assist in the delivery of force.

The one or more safety tools 115 can alternatively or additionally include one or more seatbelt cutting tools 210. The seatbelt cutting tool 210 includes a blade 225, as seen in FIG. 2B, provided in a blade slot 230 of a blade receiving member 235. The blade receiving member 235 also includes a transversely extending seatbelt slot 240 that is sized and shaped to receive the strap of a seatbelt so that the strap of a seatbelt can be slid into the seatbelt slot 240 so that it can contact the blade 225 in the blade slot 230 in a manner that will allow the blade 225 to cut the strap. A user can use the seatbelt cutting tool 210 to cut a seatbelt that is otherwise difficult or impossible to disengage and that is trapping a vehicle occupant. The blade 225 can be used to slice the entire way through the strap or can be used to start a slice in the strap so that the strap can be forced apart. The blade 225 can be removeably or permanently positioned within the blade slot 230. In the particular version shown, a blade securing mechanism 245 is provided that includes one or more blade securing members 250 that allow the blade 225 to be replaceably contained within the blade slot 230. For example, the one or more blade securing members 250 can comprise a screw or bolt that extends through a hole in the blade 225 or can be a set screw that contacts the blade 225 to hold it by friction, or the like. The blade 225 and blade receiving member 235 can be moved and/or oriented to any other position within compartment 120 or elsewhere in or on the body 105.

In the version of FIGS. 2A and 2B, the bottom portion 125 includes an escape tool compartment 120 that houses and at least partially surrounds the one or more vehicle escape tools 200. The escape tool compartment 120 is defined by a base 255 that provides a platform for the one or more escape tools 115 and one or more side walls 260 that extend from the base 255 and at least partially enclose the one or more vehicle escape tools 115. In the version shown, the side walls 260 have an end, such as a bottom edge 265, that form a surface on the vehicle escape accessory 100 can at least partially rest. In that regard, the side walls 260 can be sufficiently strong and rigid to be able to support the weight of the vehicle escape accessory 100 when oriented as shown in FIGS. 1A and 1B and placed on a surface.

When the one or more vehicle escape tools 115 comprises a window breaking tool 205, the side wall 260 can also be sufficiently weak, that it breaks or collapses when the window breaking tool 205 is advanced towards the window to be broken. For example, when swung at the window, the bottom edge 265 of the side wall 260 can contact the window before tip member 215, and the contact can break off the side wall 260 so that the tip member 215 can then advance and contact the window in either the same or a subsequent strike. Alternatively, the user can hit the side wall 260 against a hard object to break off the side wall 260 before swinging the tip member 215 at the window. Alternatively, the user can break off the side wall 260 by hand. Optionally, a scoring or otherwise weakened portion can be provided to make the breaking of the side wall 260 easier. In another version, there is no side wall 260 provided or the side wall 260 does not extend to an extent where it would interfere with the tip member 215 operation.

When the one or more vehicle escape tools 115 comprises a seatbelt cutting tool 210, the side wall 260 can be provided with one or more side wall slots 270. The one or more side wall slots 270 are adapted to receive the seat belt strap that is to be cut and can be positioned in alignment with the seatbelt slot 240. Alternatively, the seatbelt slot 240 can be incorporated into the side wall 260 so that the side wall slot 270 serves as the seatbelt slot 240. In either case, the slots can be oriented parallel to the longitudinal axis of the vehicle escape accessory 100 and/or the up and down direction and/or the direction of the tip member 215 if provided. Alternatively, the slots can be provided at an angle relative to any of those axes. In one version, a seatbelt cutting tool 210 can be provided at each of the side wall slots 270 with one or more blades associated with each of the two or more slots to make it easier for the user to determine which slot has the cutting capabilities.

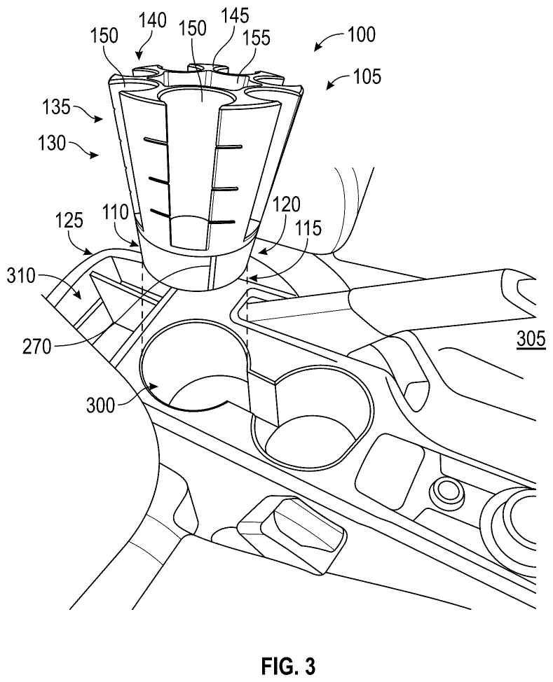

In one version, as shown in FIG. 3, the vehicle escape accessory 100 is designed to be stored, positioned, or held in a cup holder compartment 300 or other compartment, such as a storage compartment or ashtray compartment, in the interior 305 of a vehicle. Most vehicle interiors 305 include one or more cup holder compartments 300 that are designed to hold a cup or drinking container for a driver or other occupant of the vehicle. The purpose of the cup holder compartment 300 is to position a cup or other item within convenient and easy reach of the user and in a known location. By placing the vehicle escape accessory 100 within the cup holder compartment 300, the vehicle escape accessory 100 then too will be within easy reach of the user and at a known location. In the event of being trapped in a vehicle, a user would then have easy access to the vehicle escape tools 200 within the vehicle escape accessory 100 and would not have to fumble around looking for the tools or having the think about where they are located. This is particularly helpful when there has been an accident that affects the mental condition and/or wherewithal of the occupant in need of escape. To use the vehicle escape accessory 100 of the version of FIG. 3, a user would merely reach to the cup holder compartment, pull out the vehicle escape accessory 100 and orient it for either cutting a seatbelt, breaking a window, or otherwise assisting in the escape from being trapped in the vehicle.

In the version of FIG. 3, the body 105 of the vehicle escape accessory 100 is sized and shaped to be receivable within a standard size cup holder compartment 300 so that the vehicle escape accessory 100 or at least a portion thereof can be slid in and out of the cup holder compartment 300. When in place and when the vehicle is in normal use, the vehicle escape accessory 100 is stored within the cup holder compartment 300 and the escape tool region 110 is hidden from view and unnoticeable. If the vehicle escape accessory 100 has an additional accessory 140, such as the coin holder 145 as shown in FIG. 3, then the additional accessory 140 functions in its normal capacity until there is a need to remove the vehicle escape accessory 100 to use the one or more escape tools 115.

In one version, the vehicle escape accessory 100 comes as an after-market, separately purchaseable accessory that is sized and shaped to fit most conventionally sized and shaped cup holder compartments 300. In one version, the vehicle escape accessory 100 can be screwed into a cup holder or cup. Alternatively, the vehicle escape accessory 100 can be custom-fit to fit snugly within a particular cup holder accessory. Alternatively, the body 105 of the vehicle escape accessory 100 can be sized and shaped to fit into a different storage compartment 310 that is not designed to be a cup holder.

In another version, the vehicle escape accessory 100 comes as an integral part of the vehicle interior 305. For example, the vehicle manufacturer can use the space associated with a cup holder compartment 300 or a different compartment 310 and adapt the vehicle escape accessory 100 to fit within that space. In one particular version, the vehicle escape accessory 100 can be contoured and shaped to match the contour and the vehicle interior 305 so that it becomes a substantially seamless part of the vehicle interior 305.

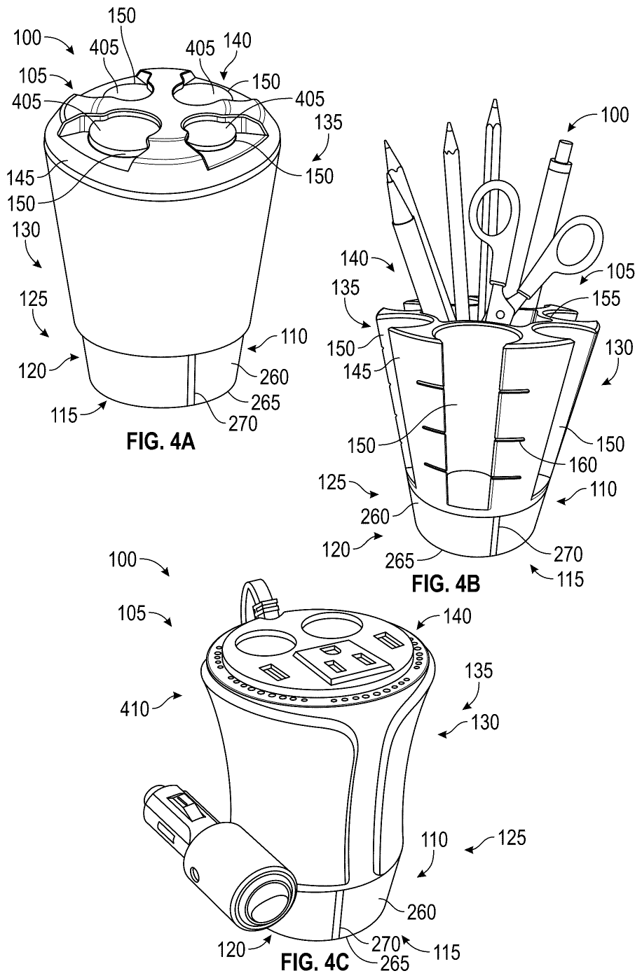

FIGS. 4A, 4B, and 4C show other examples of additional accessory 140

possibilities for the vehicle escape accessory 100. FIG. 4A shows a different type of coin holder 145 with coin slots 150 that include a biased platform 405 that urge the coins to the top of the coin slot 150. FIG. 4B shows a coin holder 145 similar to the one in FIGS. 1A and 1B but with a storage compartment 155 sufficiently deep to be able to hold pencils and/or other implements, such as a cell phone. FIG. 4C shows a version of the vehicle escape accessory 100 where the additional accessory 140 is a power supply and/or charging station 410, which can also include a slot for holding a cell phone. In another version, the additional accessory can be a cell phone holder. In another version, a combination of the features of FIGS. 4A, 4B, and/or 4C can be provided, such by having a vehicle escape accessory that is a combination coin holder and charger. In another version, the additional accessory 140 is an ashtray.

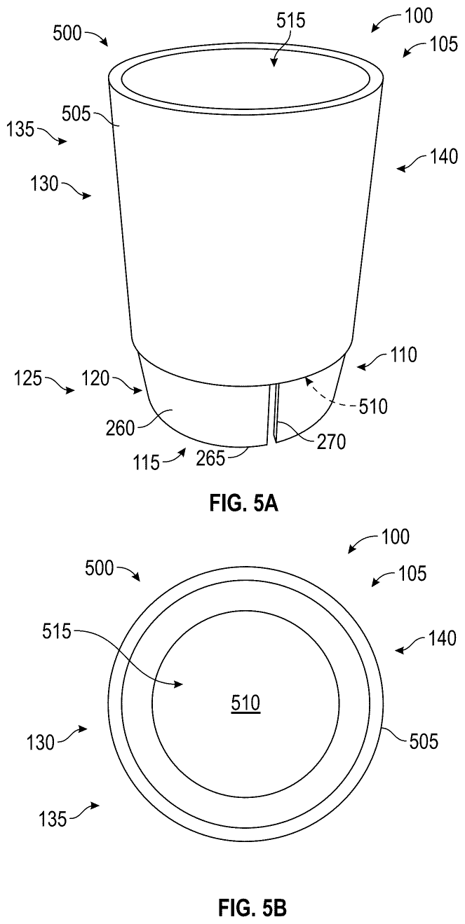

FIGS. 5A and 5B show a version of a vehicle escape accessory 100 where the additional accessory is a cup holder 500. In this version, the body 105 of the vehicle escape accessory 100 is sized and shaped to fit in a cup holder compartment 300 of a vehicle interior 305. The body 105 also has a top portion 135 with a cup holder side wall 505 and lower surface 510 that defines an interior space 515 that is sized and shaped to contain a cup or other beverage container. Accordingly, this version of the vehicle escape accessory 100 operates as a cup holder insert into a cup holder compartment 300. The side wall 505 thus mimics the cup holder compartment 300 of the vehicle and allows the space to continue to be used as a cup holder but with one or more escape tools hidden in the bottom of the insert. This insert can be provided as a separately purchased insert or can be an integral part of the cup holder compartment 300 provided by the manufacturers or after-market provider. In another version, the vehicle escape accessory 100 can be in the form of an actual cup that is adapted to hold a beverage, the cup being sized and shaped to be received within the cup holder compartment 300. The cup can be provided with or without additional features, such as a handle and/or a lid.

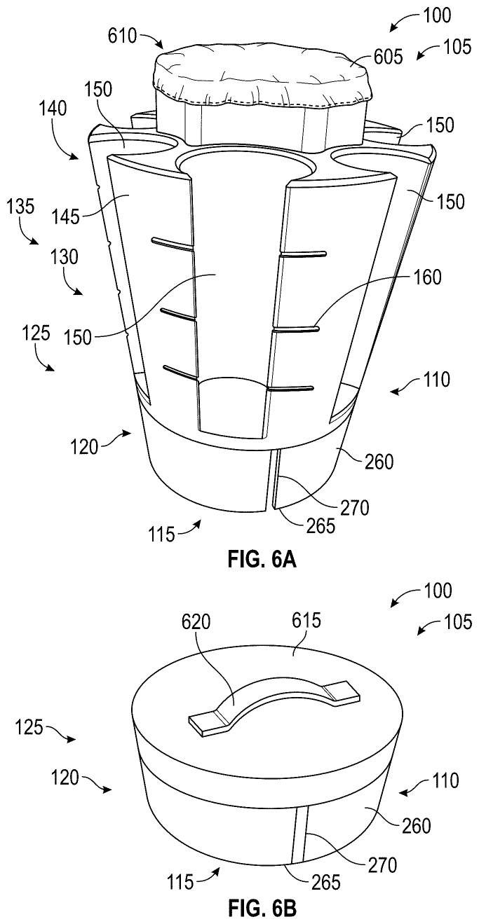

FIG. 6A shows a version of a vehicle escape accessory 100 similar to the version of FIGS. 1A and 1B. However, in this version, a padding 605 or the like is provided on the top 610 of the vehicle escape accessory 100 to help soften the impact on a user's hand if the user uses the top 610 to apply the window breaking force.

FIG. 6B shows a version of a vehicle escape accessory that does not include an additional accessory 140. In the particular version shown, the entire top portion 135 of the body 105 of the vehicle escape accessory 100 is removed. This version is particularly useful as an insert that can be inserted and/or stored in the bottom of a cup holder compartment 300 or different compartment 310 in the vehicle interior 305. In this version, a flat top 615 can be provided that will mimic the bottom of the cup holder compartment 300 or different compartment 310 so that a cup or other object can be stored in the compartment. When a user need to access the one or more escape tools 115, the user removes any cup or other object that is resting on the flat top 605 and removes the vehicle escape accessory 100 from the compartment. Optionally, a graspable member 620 or handle can be provided to help remove the vehicle escape accessory 100 from the compartment. In one version, the graspable member 620 can be screwed onto an item such as a cup or coin holder.

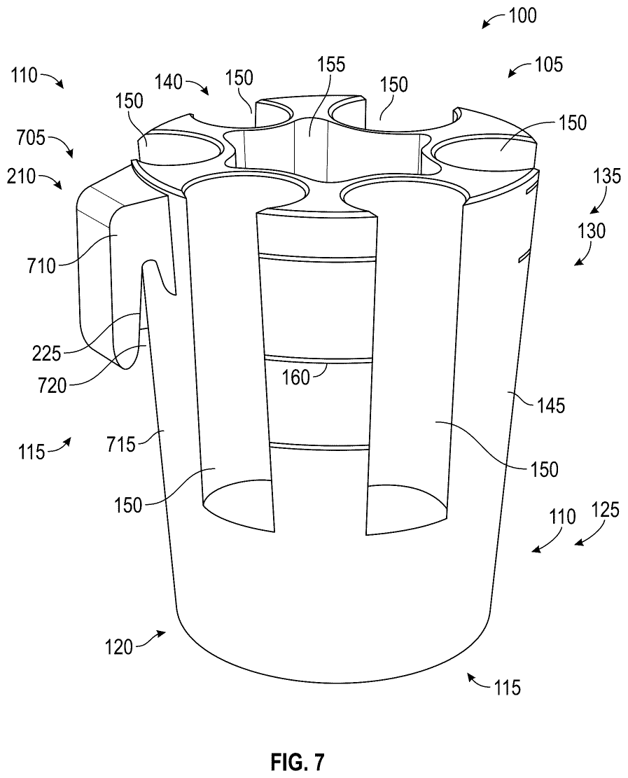

Another version of a vehicle escape accessory 100 is shown in FIG. 7. In this version, the escape tool region 110 of the body 105 of the vehicle escape accessory 100 is alternatively or additionally provided on at a position other than the bottom portion 125 of the body 105. In the version shown, the escape tool region 110 is on a side surface region 705 of the escape accessory body 105. In the version shown, the escape tool region comprises both the side surface region 705 and an escape tool compartment 120 located in the bottom portion 125 of the vehicle escape accessory body 105. In the particular version shown, the vehicle escape accessory comprises a window breaking tool 205 in the bottom compartment, as shown for example, in FIGS. 2A and 2B, and a seatbelt cutting tool 210 on the side surface 705. In this version, the seatbelt cutting tool includes an outwardly extending member 710 that extends from an outer side surface 715 of the vehicle escape accessory body 105. A seatbelt cutting blade 225 is contained within a seatbelt receiving slot 720 within the outwardly extending member 710. In use, a user can grasp the vehicle escape accessory 100 and manipulate it so that a seatbelt in need of being cut is received within the slot 720 in a manner where the blade 225 can cut the seatbelt. The outwardly extending member can also serve as a handle for the vehicle escape accessory 100. In another version, both the window breaking tool 205 and the seatbelt cutting tool 210 are in the top portion 135 or side surface region 705. In another version, the seatbelt cutting tool 210 is in the bottom portion 125 and the window breaking tool 205 is on a side surface region 705 or on the top portion 135.

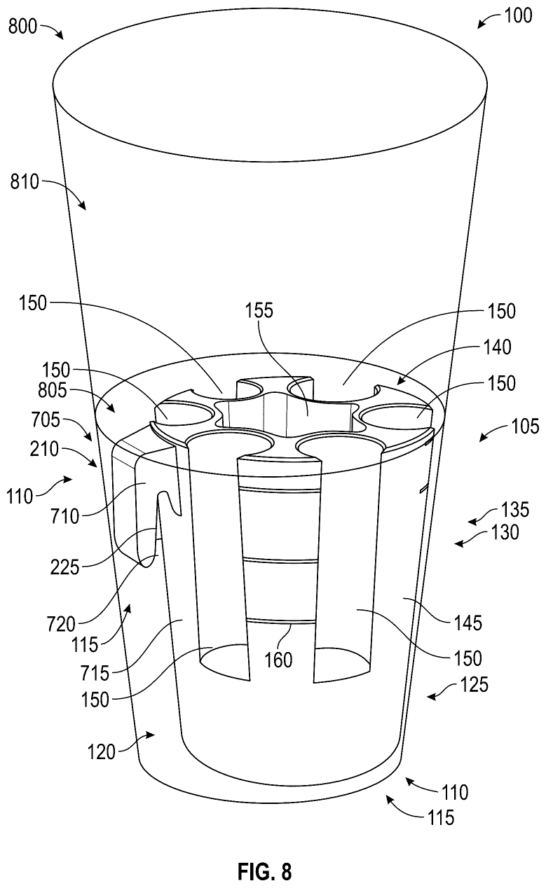

The vehicle escape accessory 100 of FIG. 7 can be inserted and/or stored within a cup holder compartment 300 or other conveniently reachable area of the vehicle as discussed above. The vehicle escape accessory can be designed to fit within a circular cupholder 300 or a U-shaped slot can be provided in the cupholder 300 to accommodate the outwardly extending member 710. FIG. 8 shows a version where the vehicle escape accessory 100 of FIG. 7 is storable in an accessory holder 800 that has a lower space 805 sized and/or shaped to contain the vehicle escape accessory 100, such as the vehicle escape accessory 100 of FIG. 7 or any other version described herein, and an upper space 810 that can receive a cup or the like. The accessory holder 800 can be a pemanent or integral part of the vehicle interior 305 or can be removeably receiveable in a cupholder compartment 300 of the vehicle. The accessory holder 800 can also optionally be provided with a U-shaped slot of the like for accommodating the outwardly extending member 710. Alternatively or additionally, the accessory holder 800 can have an upper space 810 or other region designed to hold a phone or other item and/or can be a power supply station.

The vehicle escape accessory 100 of the present invention thus provides easy and convenient access to escape tools 115 when needed. In addition, the vehicle escape accessory 100 positions the escape tools in a known location to that a user does not have to try to remember where the tools are located. This is not only useful in the rare instances when they might be needed, but the vehicle escape accessory 100 provides peace of mind for the vehicle occupant who might otherwise worry and/or have a fear of becoming trapped in a vehicle.

Though described as being useful for providing easy and convenient access to one or more vehicle escape tools 115, the vehicle escape accessory 100 can serve additional or alternative purposes. For example, the escape tool compartment 120 can be used as a secretive storage compartment for storing private items or money. The escape tool compartment 120 can also be used to store tools other than those that are specifically designed to assist with escaping a trapped situation, such as a flashlight, screwdriver, car repair tools, phone, phone holder, phone charger, battery charger, usb cable, electric outlet or adapter, and the like.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A vehicle escape accessory comprising:
a body sized and shaped to be receivable within a cup holder compartment in the interior of a vehicle; and
a vehicle escape tool in or on the body,
wherein a driver or passenger within a vehicle and in need of escaping the vehicle can remove the body from the cup holder compartment and utilize the vehicle escape tool to facilitate escape from the vehicle.

2. A vehicle escape accessory according to claim 1 wherein the vehicle escape tool comprises a window breaking tool.

3. A vehicle escape accessory according to claim 1 wherein the vehicle escape tool comprises a seatbelt cutting tool.

4. A vehicle escape accessory according to claim 1 wherein the vehicle escape tool is a first vehicle escape tool and wherein a second vehicle escape tool is provided in or on the body.

5. A vehicle escape accessory according to claim 1 wherein the vehicle escape tool comprises a window breaking tool and wherein the vehicle escape tool further comprises a seatbelt cutting tool in or on the body.

6. A vehicle escape accessory according to claim 1 wherein the body comprises an escape tool compartment in a bottom portion of the body, wherein the vehicle escape tool is contained within the escape tool compartment.

7. A vehicle escape accessory according to claim 6 wherein the vehicle escape tool is a window breaking tool.

8. A vehicle escape accessory according to claim 6 wherein the vehicle escape tool is a window breaking tool and wherein a seatbelt cutting tool is also provided in the escape tool compartment.

9. A vehicle escape accessory according to claim 6 wherein the vehicle escape tool is a window breaking tool and wherein a seatbelt cutting tool is also provided in or on the body.

10. A vehicle escape accessory according to claim 1 wherein the body comprises an additional accessory.

11. A vehicle escape accessory according to claim 10 wherein the additional accessory is a coin holder.

12. A vehicle escape accessory according to claim 10 wherein the additional accessory is a cup holder.

13. A vehicle escape accessory according to claim 10 wherein the additional accessory is a power supply station.

14. A vehicle escape accessory comprising:
a body sized and shaped to be receivable within a cup holder compartment in the interior of a vehicle;
a window breaking tool or a seatbelt cutting tool in or on the body; and
an additional accessory in or on the body,
wherein a driver or passenger within a vehicle and in need of escaping the vehicle can remove the body from the cup holder compartment and utilize the vehicle escape tool to facilitate escape from the vehicle.

15. A vehicle escape accessory according to claim 14 wherein the vehicle escape accessory comprises a window breaking tool and a seatbelt cutting tool.

16. A vehicle escape accessory according to claim 14 wherein the additional accessory comprises one or more of a coin holder, a cup holder, and a power supply station.

17. A vehicle escape accessory according to claim 14 wherein the window breaking tool or the seatbelt cutting tool is within an escape tool compartment in a bottom portion of the body and wherein the additional accessory is in a top portion of the body.

18. A method of escaping a vehicle, the method comprising:
providing an escape tool accessory in a cup holder compartment in the interior of a vehicle;
removing the escape tool accessory from the cup holder when there is a need to escape the vehicle; and
using the escape tool accessory to help facilitate escape from the vehicle.

19. A method according to claim 18 wherein the step of using the escape tool accessory to help facilitate escape from the vehicle comprises using the escape tool accessory to break a window.

20. A method according to claim 18 wherein the step of using the escape tool accessory to help facilitate escape from the vehicle comprises using the escape tool accessory to cut a seatbelt.
